(19) United States
(12) Patent Application Publication
(10) Pub. No.: US 2012/0185871 A1
(43) Pub. Date: Jul. 19, 2012

(54) Capturing Provenance Data Within Heterogeneous Distributed Communications Systems

(75) Inventors: Matthew David Allen, Richmond, VA (US); Barbara Blaustein, Silver Spring, MD (US); Leonard J. Seligman, Silver Spring, MD (US); Adriane P. Chapman, Arlington, VA (US)

(73) Assignee: MITRE Corporation, McLean, VA (US)

(21) Appl. No.: 12/917,891

(22) Filed: Nov. 2, 2010

(51) Int. Cl. G06F 9/54

(52) U.S. Cl. 719/313

(57) ABSTRACT

A system and method is provided for capturing provenance from heterogeneous distributed communication systems. A point of coordination is monitored for messages that are input to and output from applications. Each message is identified and linked and each message is linked to the application that such message is input to or output from. Numerous sequences of such interactions can be linked together to form a provenance graph.

### FIELD OF THE INVENTION

The present invention pertains to capturing provenance data within heterogeneous distributed communication systems.

### BACKGROUND OF THE INVENTION

Task execution on distributed computers typically involves one or more messages that flow through one or more applications. The messages are typically converted between multiple protocols and formats to comply with the expectations of each application. In many cases, a user's confidence in the end result depends on which applications were executed in which sequence, and how conversions were performed. To verify the integrity of the information being processed, systems have been developed to capture provenance (i.e. history of information) associated with the information flow. Tracking the flow of the information and the results at intermediate points during execution (i.e. capturing provenance data) can help establish user confidence and provide significant additional data for application analyses.

Current methods and systems for capturing provenance data involve modifying the software of each application participating in a distributed system. The software of each application is typically modified to report its output to a provenance collection mechanism at each point of interest. For example, a system can have ten participating applications. In order to capture provenance data from each of the ten applications, each application is modified to report provenance data that specifies the particular data output from the particular application.

Current computing systems span multiple systems, organizations, and integrate legacy systems with new systems. These heterogeneous distributed computing systems communicate via multiple protocols and messaging formats in various computing locations and are typically not owned or controlled by the same organization. Thus, it is impractical to capture provenance data in heterogeneous distributed computing/communication systems by modifying applications. Further, some legacy or proprietary systems cannot be modified, for example, based on the terms of their license agreements. Therefore, it is desirable to capture provenance data without modifying application (i.e. non-invasive provenance capture).

### SUMMARY OF THE INVENTION

In one aspect, the invention features a computerized method of capturing provenance from a heterogeneous distributed communications system. The method involves monitoring, by a computing device, a point of coordination to extract desired data from each message that is input to one or more applications in communication with the point of coordination. The method also involves monitoring, by the computing device, the point of coordination to extract the desired data from each message that is output from the one or more applications in communication with the point of coordination and assigning, by the computing device, a unique identifier to each previously unassigned message. The method also involves linking, by the computing device, two or more messages that include the same unique identifier and linking, by the computing device, each message to the application that such message is input to or output from. The method also involves storing, by the computing device, provenance data in memory, wherein the provenance data includes the extracted desired data from each message and the application such message is input to or output from.

In another aspect, the invention features a system for capturing provenance from a heterogeneous distributed communications system. The system includes a monitoring module that monitors a point of coordination to extract desired data from each message that is input to or output from one or more applications in communication with the point of coordination and an identifier module that assigns a unique identifier to each previously unassigned message. The system also includes a linking module that links two or more messages that includes the same unique identifier and links each message to the application that such message is input to or output from and a storing module that stores provenance data in memory, wherein the provenance data includes the extracted desired data from each message, and the application such message was input to or output from.

In some embodiments, the system includes a display module that transmits a provenance graph that is based on the linked messages and the links between message and the application the message is input to or output from to a display.

In some embodiments, the point of coordination is an enterprise service bus. In some embodiments, the point of coordination is a web proxy or a HTTP proxy. In some embodiments, the desired data from each message includes data fields that are specified by receiving input by the computing device.

In some embodiments, the method involves determining, by the computing device, the desired data for each message based on a particular service the message is transmitted to or transmitted from. In some embodiments, the method involves transmitting, by the computing device, a provenance graph that is based on the linked messages and the linked messages to application, to a display.

### BRIEF DESCRIPTION OF THE DRAWINGS

The foregoing features of the invention will be more readily understood by reference to the following detailed description, taken with reference to the accompanying drawings, in which:

FIG. 1 is a diagram showing an exemplary heterogeneous distributed communications system.

FIG. 2 is a diagram of a system for capturing provenance from a heterogeneous distributed communication system, according to an illustrative embodiment of the invention.

FIG. 3 is flowchart of a method for capturing provenance from a heterogeneous distributed communication system, according to an illustrative embodiment of the invention.

FIG. 4A is diagram of a system for capturing provenance data from an exemplary heterogeneous distributed communication system.

FIG. 4B is a diagram of a provenance graph

FIG. 5 is a diagram of a provenance graph.

### DETAILED DESCRIPTION OF ILLUSTRATIVE EMBODIMENTS

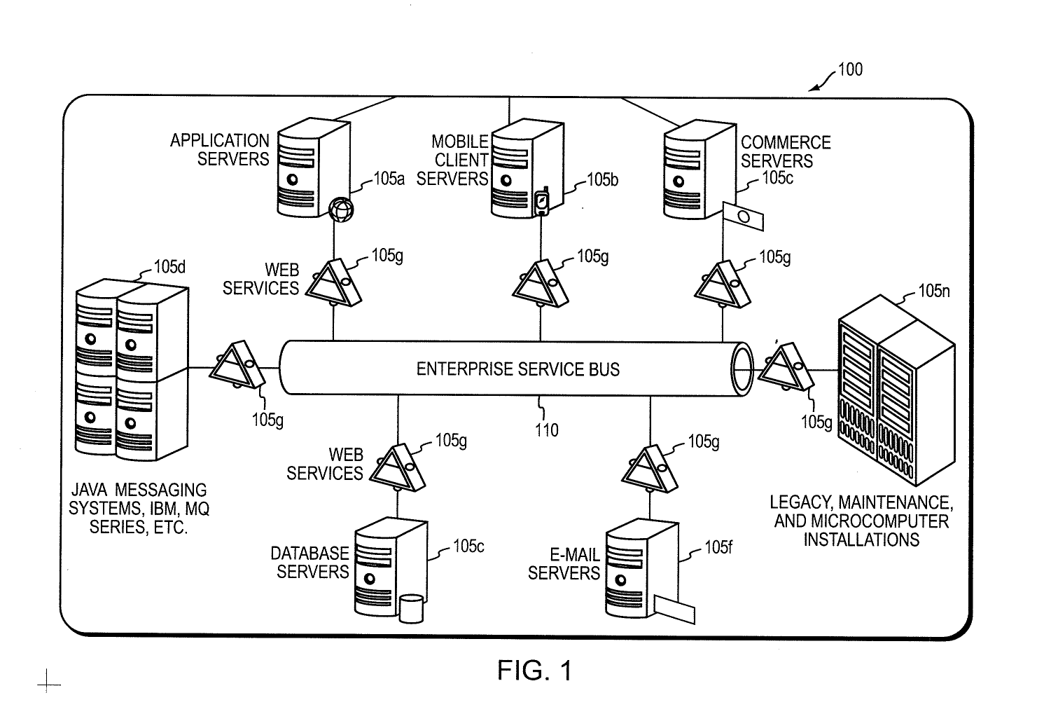

FIG. 1 is a diagram showing an exemplary heterogeneous distributed communications system 100. The system 100 includes a point of coordination (e.g. enterprise service bus 110 or server) that connects applications that are executed over web services 105g on one or more of application servers 105a, mobile client servers 105b, commerce servers 105c, a java messaging system 105d, database servers 105e, email servers 105f, legacy mainframe systems 105n, and/or any type of computing/communication system.

The enterprise service bus 110 can include one or more system tools (not shown) that integrate the various types of applications. For example, the tools can integrate information formatted in Java Messaging Service (JMS), Hypertext Transfer Protocol (HTTP), Extensible Markup Language (XML), and/or Java Database Connectivity (JBDC). The tools can be custom tools or commercially available tools, such as plugins or additional software modules that integrate with existing enterprise service bus tools (e.g., Mule, BEA AquaLogic SB, Cape Clear ESB and/or Fiorano ESB). The tools can be used to mediate messages from one format to another format as they pass between applications, so that an application which produces outputs in one format can communicate with an application which requires a differently formatted input, via the translation or mediation of the message in the middle.

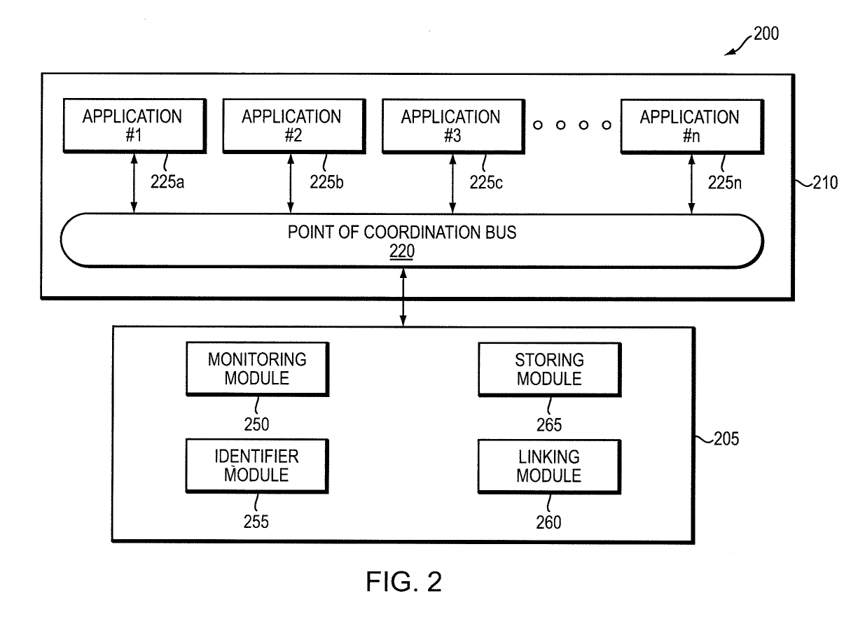

FIG. 2 is a diagram 200 of a system 205 for capturing provenance from a heterogeneous distributed communication system 210, according to an illustrative embodiment of the invention. The heterogeneous distributed communication system 210 includes a point of coordination 220 and application 225a, application 2225b, application 225c, and application 225n, generally applications 225. The applications 225 communicate via the point of coordination 220.

In some embodiments, the point of coordination 220 is an enterprise service bus as discussed above in FIG. 1. In some embodiments, the point of coordination 220 is a web proxy. In some embodiments, the point of coordination 200 is a business process execution language engine (BPEL) or a workflow engine. In some embodiments, the applications 225 are data services, web applications, SaaS applications, mainframe applications, java messaging services, email services, database services, commerce services, mobile client services, and/or any other application. In some embodiments, the applications 225 communicate via the point of coordination 220 using HTTP, XML, JDBC, JMS, FTP, SOAP, email, SMS, and/or other communication protocols.

The system 205 includes a monitoring module 250, an identifier module 255, a linking module 260, and a storing module 265.

The monitoring module 250 monitors the point of coordination 220 for messages that are input to or output from the point of coordination 220. The monitoring module 250 also extracts desired data from each of the messages. In some embodiments, the desired data is input to system 205 via a user (not shown). In some embodiments, a user interface can display to the user data descriptors that indicate which data is available to be captured. The user can select from the data descriptors to specify the exact data to be captured. In some embodiments, the desired data is set by default. In some embodiments, the monitoring module 250 determines the data that is available to be captured and selects the exact data that is to be captured. In some embodiments, the desired data is determined by the monitoring module 250 based on a particular service the message is transmitted to or transmitted from. In some embodiments, the desired data is extracted by using Java's Reflection API's.

The identifier module 255 assigns each previously unassigned message that flows across the point of coordination 220 a unique identifier. For example, assume a message is output from application 225a. The identifier module 255 determines if the message output from application 225a has been assigned a unique identifier. Assume the message output from application 225a does not have a unique identifier; the identifier module 255 assigns the message output from application 225a a unique identifier of X. Assume the message output from application 225a is input to applications 225b and 225c. The identifier module 225 checks if the input to application 225b has a unique identifier, and determines the input to application 225b has a unique identifier of X. Thus, the identifier module 255 does not assign a unique identifier to the message input to application 225b. The identifier module 225 checks if the input to application 225c has a unique identifier, and determines the input to application 225c has a unique identifier of X. Thus, the identifier module 255 does not assign a unique identifier to the message input to application 225c. Any number of messages input to applications and any number of message output from applications can share the same unique identifier. Any single message can be input to one application and output from another application. For example, a message can be an output to application 225a and be input to application 225b and application 225c.

The linking module 260 links two or more messages that include the same unique identifier. For example, assume a message output from application 225c has a unique identifier of Y. Also assume that message input to application 225n has a unique identifier of Y. The linking module 260 recognizes that the output message from application 225c and the input message to application 225n are the same message because each message shares the same unique identifier of Y. The linking module 260 also links each message to the particular application that such message is input to or output from. Continuing with the above example, linking module 260 associates the message with unique identifier Y as being output from application 225c and input to application 225n.

The storing module 265 stores provenance data in memory. The provenance data can include the unique identifier, the data extracted from each message by the monitoring module 250 and the link between messages and the application the message was input to or output from. One of ordinary skill in the art should easily recognize that the memory can be any memory device, such as semiconductor, magnetic, optical or other memory devices.

In some embodiments, system 205 includes a display module (not shown). The display module transmits a provenance graph that is based on the linked messages and the linked message to application to a display.

The heterogeneous distributed communication system 210 can be any heterogeneous distributed communication system. The heterogeneous distributed communication system 210 operates independent of system 205. System 205 can monitor heterogeneous distributed communication system 210 without modifying any part of heterogeneous distributed communication system 210. Thus, system 205 captures provenance data in a way that is non-invasive with respect to applications 225a, 225b, . . . , 225n. In addition, the system 205 can capture provenance data from communication systems that are not distributed or heterogeneous.

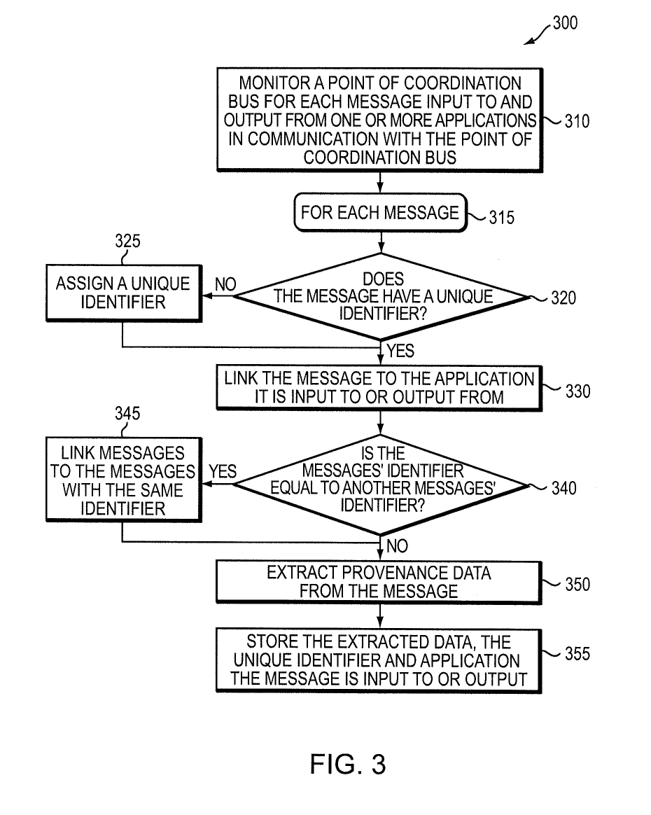

FIG. 3 is flowchart 300 of a method for capturing provenance from a heterogeneous distributed communication system (e.g., heterogeneous distributed communication system 210 as described above in FIG. 2), according to an illustrative embodiment of the invention. The method includes monitoring a point of coordination (e.g., point of coordination 220 as described above in FIG. 2) for each message input to and output from one or more applications (e.g. applications 225 as described above in FIG. 2) in communication with the point of coordination (Step 310).

The method also includes, for each message (Step 315) determine if the message has a unique identifier (Step 320). If the message does not have a unique identifier, then assign a unique identifier to the message (Step 325).

The method also includes linking the message to the application it is input to or output from (Step 330). The method also includes determining if the message's identifier is the same as any other messages' identifier (Step 340). If the message's identifier if the same as any other messages' identifier, then link the messages with the same identifiers (Step 345). Messages with the same identifier can be previously seen provenance nodes with the same identifier.

The method also includes extracting provenance data from the message (Step 350). The method also includes storing the provenance data (e.g., the extracted data, the links between the message with the same identifier, and the links between the message and the applications it is input to or output from) (Step 355).

In some embodiments, the method includes transmitting the provenance data in the form of a provenance graph to a display.

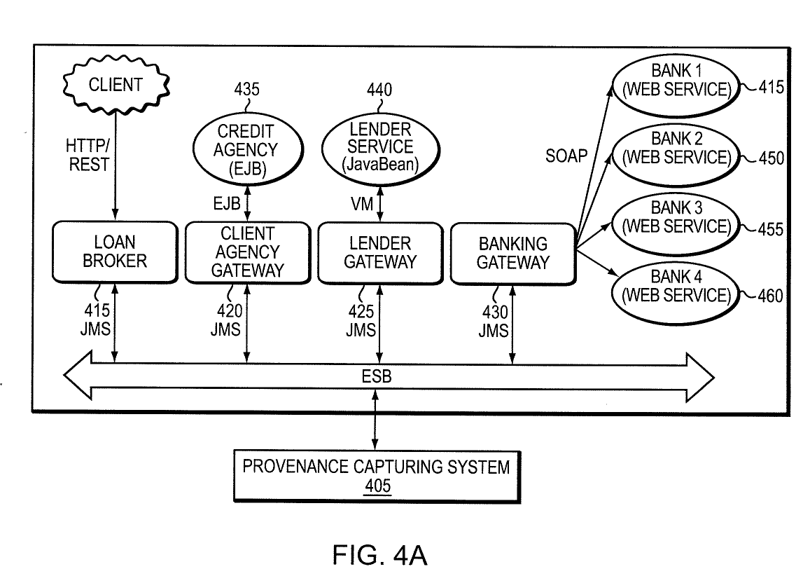

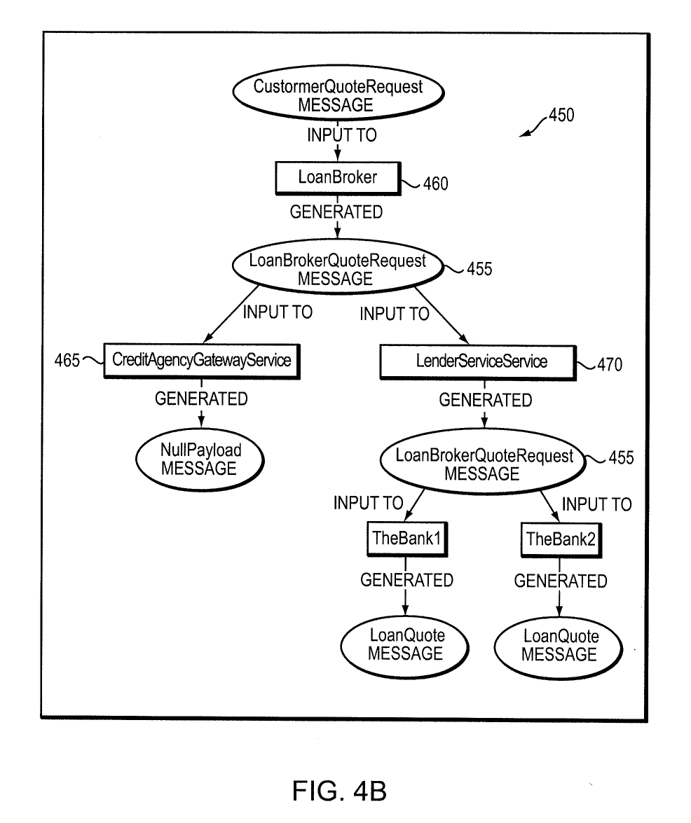

FIG. 4A is diagram of a system 405 for capturing provenance data from an exemplary heterogeneous distributed communication system 400. The heterogeneous distributed communication system 400 includes an enterprise service bus 410 in communication with applications to complete a loan quote via a JMS protocol. The applications include a loan broker 415, a client agency gateway 420, a lender gateway 425 and a banking gateway 430. Each of the applications communicates with other system elements to complete the loan quote. System 405 can capture provenance data from heterogeneous distributed communication system 400. System 405 can also build a provenance graph that illustrates the history of messaging during the loan quote.

FIG. 4B is a diagram of an exemplary provenance graph 450 generated by a provenance capturing system (e.g., provenance capturing system 405 as discussed in FIG. 4A). Loan broker 415, client agency 420, lender gateway 425 and banking gateway 430 are applications. Credit agency (EJB) 435, lender service (JavaBean) 440, Bank 1 (web service) 445, Bank 2 (web service) 450, Bank 3 (web service) 455, and Bank 4 (web service) 460 are messages and data that are passed between applications. The provenance graph 450 results from monitoring an enterprise service bus (e.g., enterprise service bus 410 as discussed in FIG. 4A), linking messages with the same unique identifier and linking messages to applications. For example, the provenance capturing system determined that the LoanBrokerQuoteRequest message 455 was output from the LoanBroaker application 460 and input to the CreditAgencyGatewayService application 465 and input to the LenderServiceService application 470. The provenance capturing system also determined that the LoanBroakerQuoteRequest message 455 output from the LenderServiceService application 470 is the same message as the LoanBroakerQuoteRequest message 455 from output from the LoanBroker application 460.

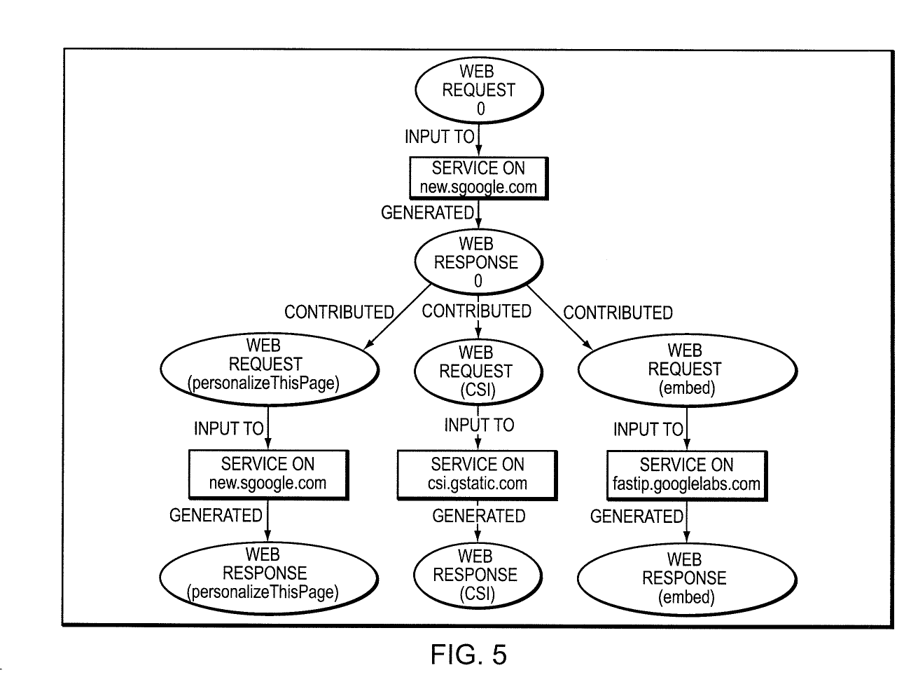

FIG. 5 is a diagram of an exemplary provenance graph 500 generated by a provenance capturing system monitoring a point of coordination that is a web proxy. In some embodiments, a provenance graph includes messages and processes invoked via HTTP.

The above described techniques can be implemented in a variety of ways. The components of the system can be interconnected by any form or medium of digital data communication (e.g., a communication network). The system can include clients and servers. A client and a server are generally remote from each other and typically interact through a communication network. The relationship of client and server arises by virtue of computer programs running on the respective computers and having a client-server relationship to each other.

One skilled in the art can appreciate the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A computerized method of capturing provenance from a heterogeneous distributed communications system, comprising:
monitoring, by a computing device, a point of coordination to extract desired data from each message that is input to one or more applications in communication with the point of coordination;
monitoring, by the computing device, the point of coordination to extract the desired data from each message that is output from the one or more applications in communication with the point of coordination;
assigning, by the computing device, a unique identifier to each previously unassigned message;
linking, by the computing device, two or more messages that include the same unique identifier;
linking, by the computing device, each message to the application that such message is input to or output from; and
storing, by the computing device, provenance data in memory, wherein the provenance data includes the extracted desired data from each message and the application such message is input to or output from.

2. The computerized method of claim 1, wherein the point of coordination is an enterprise service bus.

3. The computerized method of claim 1, wherein the point of coordination is a web proxy or a HTTP proxy.

4. The computerized method of claim 1, wherein the desired data from each message includes data fields that are specified by receiving input by the computing device.

5. The computerized method of claim 1 further comprising:
determining, by the computing device, the desired data for each message based on a particular service the message is transmitted to or transmitted from.

6. The computerized method of claim 1 further comprising:
transmitting, by the computing device, a provenance graph that is based on the linked messages and the linked messages to application, to a display.

7. A system for capturing provenance from a heterogeneous distributed communications system, comprising:
a monitoring module that monitors a point of coordination to extract desired data from each message that is input to or output from one or more applications in communication with the point of coordination;
an identifier module that assigns a unique identifier to each previously unassigned message;
a linking module that links two or more messages that includes the same unique identifier and links each message to the application that such message is input to or output from; and
a storing module that stores provenance data in memory, wherein the provenance data includes the extracted desired data from each message, and the application such message was input to or output from.

8. The system of claim 7, wherein the point of coordination is an enterprise service bus.

9. The system of claim 7, wherein the point of coordination is a web proxy or HTTP proxy.

10. The system of claim 7, wherein the desired data from each message includes data fields that are specified by receiving input by the computing device.

11. The system of claim 7, further comprising:
determining, by the computing device, the desired data for each message based on a particular service the message is transmitted to or transmitted from.

12. The system of claim 7, further comprising a display module that transmits a provenance graph that is based on the linked messages and the linked message to application to a display.
